(19) United States
(12) Patent Application Publication
(10) Pub. No.: US 2013/0055228 A1
(43) Pub. Date: Feb. 28, 2013

(54) System and Method for Installing a Patch on a Computing System

(71) Applicants: Zhexuan Song, Sunnyvale, CA (US); Seigo Kotani, Kawasaki (JP)

(72) Inventors: Zhexuan Song, Sunnyvale, CA (US); Seigo Kotani, Kawasaki (JP)

(73) Assignee: Fujitsu Limited, Kanagawa (JP)

(21) Appl. No.: 13/220,298

(22) Filed: Aug. 29, 2011

(51) Int. Cl. G06F 9/445; G06F 9/44

(52) U.S. Cl. 717/168

(57) ABSTRACT

According to one embodiment, a system includes a memory and a processor. The processor receives a message that includes a patch for installation and one or more requirements to be satisfied before the patch can be installed. The patch is configured to update the computing system. The processor also repeatedly collects information from one or more sensors until it is determined, based on the collected information, that the one or more requirements have been satisfied. Upon determining that the one or more requirements have been satisfied, the processor further conducts an installation process of the patch on the computing system. Upon determining that the installation process of the patch is finished, the processor further transmits a confirmation report indicating whether the patch was successfully installed. The confirmation report is generated and signed by a unique element associated with the computing system.

### TECHNICAL FIELD

This disclosure relates generally to the field of computing systems and more specifically to a system and method for installing a patch on a computing system.

### BACKGROUND

Typically, a computing system may install a patch by first determining that a patch is needed (e.g., such as checking for an update) and then downloading the patch for immediate installation on the computing system. Alternatively, a computing system may also typically install a patch based on a user of the computing system manually selecting to download the patch and immediately installing the patch once it is downloaded. Such patch installation processes, however, may be deficient. In particular, such processes may be problematic for computing systems that are embedded in a device (e.g., embedded computing devices) and/or computing systems that implement virtual machines.

### SUMMARY OF THE DISCLOSURE

According to one embodiment, a system includes a computing system that includes a unique element for generating and signing one or more reports so as to identify the reports as being associated with the computing system. The computing system further includes a memory and a processor. The processor receives a message that includes a patch for installation and one or more requirements to be satisfied before the patch can be installed. The patch is configured to update the computing system. The processor also repeatedly collects information from one or more sensors until it is determined, based on the collected information, that the one or more requirements have been satisfied. Upon determining that the one or more requirements have been satisfied, the processor further conducts an installation process of the patch on the computing system. Upon determining that the installation process of the patch is finished, the processor further transmits a confirmation report indicating whether the patch was successfully installed. The confirmation report is generated and signed by a unique element associated with the computing system.

Certain embodiments of the disclosure may provide one or more technical advantages. For example, by requiring that requirements be satisfied prior to a patch being installed on a computing system, the creator (and/or provider) of the patch may be able to ensure that the patch is installed in the computing system at a time when the installation is likely to be successful, when the installation is not dangerous, and/or when the installation is appropriate for the computing system.

As another example, by requiring that requirements be satisfied prior to a patch being installed on a computing system, patches may be installed on a computing system that is embedded in a device and/or a computing system that is implementing virtual machines. As a further example, by transmitting a confirmation report that indicates whether the patch was successfully installed, the confirmation report may be stored by a third party (e.g., such as a manufacturer) as evidence of whether or not the patch was successfully installed on the computing system.

Certain embodiments of the disclosure may include none, some, or all of the above technical advantages. One or more other technical advantages may be readily apparent to one skilled in the art from the figures, descriptions, and claims included herein.

### BRIEF DESCRIPTION OF THE DRAWINGS

For a more complete understanding of the present disclosure and its features and advantages, reference is now made to the following description, taken in conjunction with the accompanying drawings, in which:

FIG. 1 illustrates a system that provides for installation of a patch on a computing system, such as a computing system embedded in a device;

FIG. 2 illustrates a system that provides for installation of a patch on a computing system that implements one of more virtual machines;

FIG. 3 illustrates a method for installing patches on computing systems;

FIG. 4 illustrates a method for generating check points for particular embodiments of the computing system in the method of FIG. 3; and

FIG. 5 illustrates a method for selecting a patch for a computing system.

### DETAILED DESCRIPTION OF THE DRAWINGS

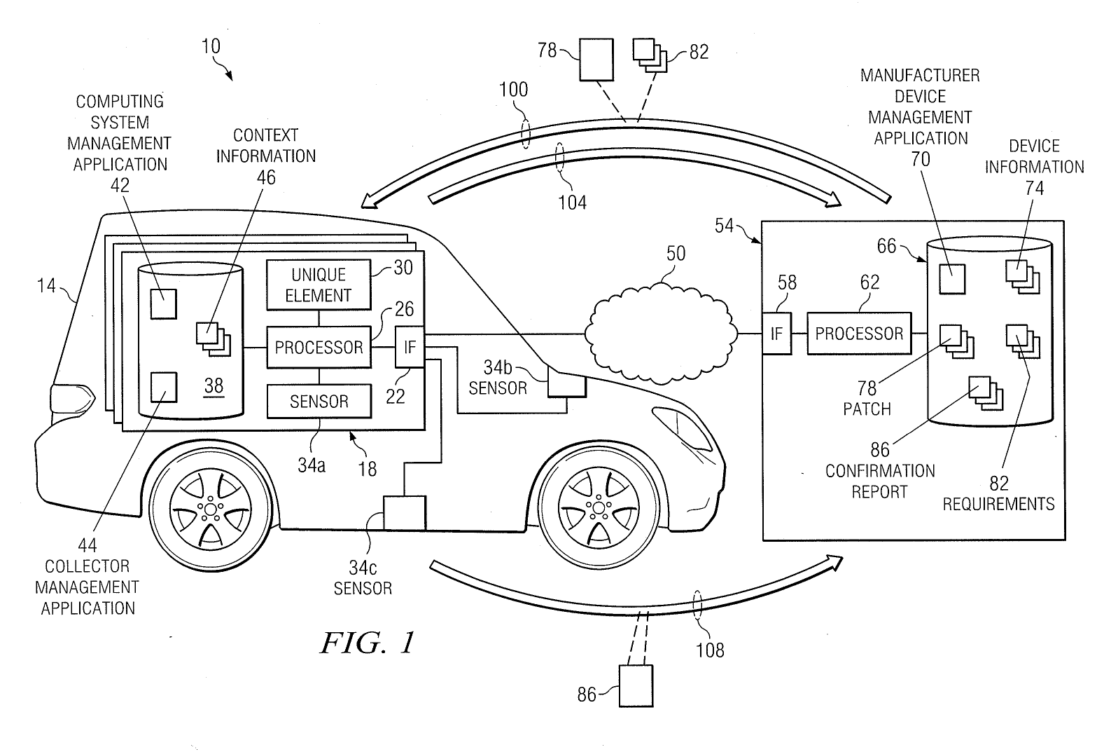

Embodiments of the present disclosure are best understood by referring to FIGS. 1 through 5 of the drawings, like numerals being used for like and corresponding parts of the various drawings.

FIG. 1 illustrates a system 10 that provides for installation of a patch on a computing system, such as a computing system embedded in a device. System 10 includes a device 14 that includes a computing system 18 embedded in the device 14. Computing system 18 receives a patch 78 and one or more requirements 82 from a manufacturer device 54. Once computing system 18 determines that requirements 82 have been satisfied, computing system 18 may conduct an installation process for installing patch 78 on computing system 18. In particular embodiments, this may allow computing system 18 to install patch 78 even though computing system 18 is embedded in device 14.

A patch (such as patch 78) may represent a set of instructions, logic or code for installation on a computing system. A patch may be designed to fix known problems associated with a computing system and/or may be designed to update a computing system, one or more applications and/or instructions associated with the computing system, and/or any data stored or supporting the computing system. In particular embodiments, by installing a patch, the computing system may fix one or more security issues (such as vulnerabilities in the computing system) and/or one or more bugs associated with the computing system. Furthermore, installation of a patch may further improve the usability and/or performance of the computing system, one or more applications and/or instructions associated with the computing system, and/or any data stored or supporting the computing system. A patch may be configured to fix and/or update a portion of the computing system or the entire computing system. Furthermore, the patch may have any size, such as from a few kilobytes to hundreds of megabytes, or larger.

Requirements may represent information regarding what is required in order for a patch to be installed in a computing system. In particular embodiments, by requiring that the requirements be satisfied prior to a patch being installed on a computing system, the creator (and/or provider) of the patch may be able to ensure that the patch is installed in the computing system at a time when the patch is likely to be successful, when the installation is not dangerous, and/or when the installation is appropriate for the computing system.

Typically, a computing system may install a patch by first determining that a patch is needed (such as checking for an update), and then downloading the patch for immediate installation on the computing system. Alternatively, a computing system may also typically install a patch based on a user of the computing system manually selecting to download the patch and immediately installing the patch once it is downloaded. Such patch installation processes, however, may be deficient for various computing systems. For example, a computing system embedded in a device may be unable to install a patch in such a manner because the device in which the computing system is embedded may be functioning (or otherwise operating in any other manner), rendering such an installation process unsafe and/or unsuccessful. As another example, since other computing systems may be implementing virtual machines that may be used by third parties, installing a patch on these computing systems in the typical manner may be problematic because the computing system may be unable to shut down the virtual machines whenever the patch is ready for installation.

In addition to the above deficiencies, further problems may be associated with the typical processes for installing a patch on a computing system. For example, because certain computing systems may be embedded in a device designed and/or manufactured by a business entity (e.g., such as a manufacturer of the device), the business entity may require proof of an installation of the patch. In particular, such proof may allow the business entity to defend itself against one or more claims if the device malfunctions or is destroyed. Unfortunately, the typical installation processes fail to provide such proof to the business entity. As such, typical patch installation methods for computing systems are further deficient.

Device 14 represents any device that includes computing system 18 embedded in the device. Device 14 may include an automobile, a mobile phone, a digital versatile disk (DVD) player, a digital camera, a printer, an electronic medical device, any other device that includes computing system 18 embedded in the device, or any combination of the preceding. In particular embodiments, device 14 may have various functionalities and/or abilities, and computing system 18 may only contribute to a subset of such functionalities and/or abilities. In particular embodiments, in addition to computing system 18, device 14 may further include additional hardware, mechanical parts, electrical parts, or any other type of parts for providing the various functionalities and abilities of device 14.

As is discussed above, computing system 18 is embedded in device 14. As such, computing system 18 may be referred to as an “embedded computing system.” An embedded computing system may include a computing system designed to contribute to one or more functionalities and/or abilities of the device it is embedded in. For example, the embedded computing system may be designed to do one or more dedicated and/or specific functions of the device it is embedded in. In particular embodiments, the embedded computing system may operate and/or provide functionality to hardware, software, mechanical parts, and/or electrical parts of device 14. In particular embodiments, since an embedded computing system is embedded in a device, the embedded computing system may not be a standalone device. In particular embodiments, since an embedded computing system is embedded in a device, the embedded computing system may have no user interface (or may have a very limited user interface). In particular embodiments, since an embedded computing system is embedded in a device, the embedded computing system may be unavailable for installing a patch whenever the patch is available. For example, since the device may be functioning (or otherwise operating in any manner), an installation of a patch on the embedded computing system may be unsafe and/or may be unsuccessful at particular times. Thus, the embedded computing system may be unable to install a patch until the device is no longer hindering the installation process.

Computing system 18 represents any components that contribute to one or more functionalities and/or abilities of device 14. For example, in an embodiment where device 14 is an automobile, computing system 18 represents any components that may contribute to one or more functionalities and/or abilities of the automobile, such as controlling the anti-lock braking system (ABS), the electronic stability control (ESC/ESP), the traction control (TCS), the automatic four-wheel drive, various aspects of the motor of the automobile, various aspects of a DVD player or global positioning system (GPS) installed in the automobile, or any other functionality and/or ability of the automobile.

Computing system 18 may include hardware, software, or a combination thereof, operable to contribute to one or more functionalities and/or abilities of device 14. The functions of computing system 18 may be performed by any combination of components at one or more locations in device 14. In the illustrated embodiment, computing system 18 includes a network interface 22, a processor 26, a unique element 30, one or more sensors 34, and a memory 38.

Network interface 22 represents any device operable to receive information from network 50, transmit information through network 50, perform processing of information, communicate to other devices, or any combination of the preceding. For example, network interface 22 receives a message that includes patch 78 and requirements 82 from manufacturer device 54. As another example, network interface 22 communicates a message that includes a confirmation report 86 to manufacturer device 54. Network interface 22 represents any port or connection, real or virtual, including any suitable hardware and/or software, including protocol conversion and data processing capabilities, to communicate through a local area network (LAN), a metropolitan area network (MAN), a wide area network (WAN), or other communication system that allows computing system 18 to exchange information with sensors 34, network 50, manufacturer device 54, or other components of system 10.

Processor 26 communicatively couples to network interface 22 and memory 38, and controls the operation and administration of computing system 18 by processing information received from network interface 22 and memory 38. Processor 26 includes any hardware and/or software that operates to control and process information. For example, processor 26 executes computing system management application 42 to control the operation of computing system 18, and further executes collector management application 44 to control the installation of patch 78. Processor 26 may be a programmable logic device, a microcontroller, a microprocessor, any processing device, or any combination of the preceding.

Unique element 30 represents any component that is uniquely associated with computing system 18. In particular embodiments, unique element 30 may be a hardware-based component (such as a trusted platform module (TPM) or any other computer chip or device that is uniquely associated with computing system 18), or a software-based component (such as one or more instructions and/or applications that are uniquely associated with computing system 18). In particular embodiments, unique element 30 may include a unique key, unique product identifier, any other unique identifier, or any combination of the preceding. In particular embodiments, the unique identifier may be a secret identifier that is included in unique element 30 when unique element is produced. Since unique element 30 both includes such a unique identifier and is also associated with computing system 18 (e.g., such as by being physically coupled (or bound) to computing system 18, or installed only on computing system 18), unique element 30 may be uniquely associated with computing system 18. In particular embodiments, because unique element 30 is uniquely associated with computing system 18, unique element 30's signature on (and/or generation of) a message, report, or any other communication identifies the communication as being associated with computing system 18. As such, a third party that receives the communication that is signed (and/or generated) by unique element 30 may be able to trust that the communication is associated with computing system 18. In particular embodiments, since the third party may be able to trust the communications that are signed (and/or generated) by unique element 30, unique element 30 may be referred to as a “trust anchor.”

Sensor 34 represents any sensing element that may collect information (such as context information 46) associated with device 14 and/or computing system 18. Sensor 34 may include a temperature based sensor (e.g., such as for collecting information associated with the temperature inside and/or outside of device 14), an automotive-based sensor (e.g., such as a engine monitoring sensor, a speedometer sensor, an air-fuel ratio sensor, a tire-pressure monitoring sensor, and/or a vehicle speed sensor), a chemical-based sensor (e.g., such as a nitrogen oxide sensor) an electrical-based sensor (e.g., such as a voltage detector) an environment-based sensor (e.g., such as a rain sensor), a software-based sensor (e.g., such as a sensor that collects information that indicates the current workload of a processing system), any other sensor, or any combination of the preceding. In particular embodiments, sensor 34 may collect information associated with device 14 and/or computing system 18 so that computing system 18 may determine whether patch 78 may be installed. In particular embodiments, sensor 34 may collect the information by monitoring the device 14 and/or computing system 18.

Memory 38 stores, either permanently or temporarily, data, operational software, or other information for processor 26. Memory 38 includes any one or a combination of volatile or non-volatile local or remote devices suitable for storing information. For example, memory 38 may include random access memory (RAM), read only memory (ROM), magnetic storage devices, optical storage devices, or any other information storage device or a combination of these devices. While illustrated as including particular modules, memory 38 may include any information for use in the operation of computing system 18.

In the illustrated embodiment, memory 38 includes computing system management application 42, collector management application 44, and context information 46. Computing system management application 42 represents any suitable instructions, logic or code embodied in a computer-readable storage medium and operable to facilitate the operation of computing system 18. For example, computing system management application 38 may be operable to facilitate the ability of computing system 18 to contribute to one or more functionalities and/or abilities of device 14.

Collector management application 44 represents any suitable set of instructions, logic, or code embodied in a computer-readable storage medium and operable to facilitate that installation of patch 78 on computing system 18. For example, collector management application 44 may collect context information 46 from sensors 34. As such, in particular embodiments, collector management application 44 and sensors 34 may be collectively referred to as a “context collector.” In particular embodiments, collector management application 44 may further determine when patch 78 may be installed on computing system 18. For example, collector management application 44 may compare context information 46 to requirements 82 in order to determine whether patch 78 may be installed on computing system 18.

Context information 46 represents any information collected from sensors 34.

For example, in an embodiment where device 14 comprises an automobile, context information 46 may include information that indicates that the automobile has exceeded 80,000 miles, was built more than five years ago, has an engine that is currently off, has an engine that is currently at room temperature, and/or any other information. Context information 46 may include any information that is associated with requirements 82. For example, context information 46 may include any information that may be compared with requirements 82 in order to determine whether requirements 82 have been satisfied.

Network 50 represents any network operable to facilitate communication between the components of system 10, such as device 14, computing system 18, and manufacturer device 54. Network 50 may include any interconnecting system capable of transmitting audio, video, signals, data, messages, or any combination of the preceding. Network 50 may include all or a portion of a public switched telephone network (PSTN), a public or private data network, a LAN, a MAN, a WAN, a local, regional, or global communication or computer network, such as the Internet, a wireline or wireless network, an enterprise intranet, or any other communication link, including combinations thereof, operable to facilitate communication between the components. In particular embodiments, network 50 may include all or a portion of a satellite-enabled communications network or cellular-based communications network.

Manufacturer device 54 represents any components that may transmit patch 78 to computing system 18 for installation. In particular embodiments, manufacturer device 54 may further represent any components that may receive confirmation report 86 and store confirmation report 86 as evidence of whether the installation of patch 78 was successful. In particular embodiments, manufacturer device 54 may be a device associated with the manufacturer of device 14. For example, in an embodiment where device 14 is an automobile, manufacturer device 54 may be associated with the manufacturer of the automobile. In particular embodiments, manufacturer device 54 may be a device associated with the manufacturer of computing system 18 (or one or more components of computing system 18). In particular embodiments, manufacturer device 54 may be a device associated with a manufacturer of patch 78 for computing system 18. For example, manufacturer device 54 may be a device associated with a software company that creates patch 78 for computing system 18.

Manufacturer device 54 may include a network server, any remote server, a mainframe, a host computer, a workstation, a web server, a personal computer, a file server, or any other device operable to facilitate transactions between users and recipients. The functions of manufacturer device 54 may be performed by any combination of one or more servers or other components at one or more locations. In the embodiment where the module is a server, the server may be a private server, and the server may be a virtual or physical server. The server may include one or more servers at the same or remote locations. Also manufacturer device 54 may include any component that functions as a server. Although FIG. 1 illustrates the same manufacturer device 54 as both transmitting patch 78 to computing system 18 and receiving confirmation report 86 from computing system 18, in particular embodiments, different manufacturer devices 14 may conduct one or more operations of manufacturer device 54. In the illustrated embodiment, manufacturer device 54 includes a network interface 58, a processor 62, and a memory 66.

Network interface 58 represents any device operable to receive information from network 50, transmit information through network 50, perform processing of information, communicate to other devices, or any combination of the preceding. For example, network interface 58 receives a message that includes confirmation report 86 from computing device 18. As another example, network interface 58 communicates a message that includes patch 78 and requirements 82 to computing device 18. Network interface 58 represents any port or connection, real or virtual, including any suitable hardware and/or software, including protocol conversion and data processing capabilities, to communicate through a LAN, a MAN, a WAN, or other communication system that allows manufacturer device 54 to exchange information with network 50, device 14, computing system 18, or other components of system 10.

Processor 62 communicatively couples to network interface 58 and memory 66, and controls the operation and administration of manufacturer device 54 by processing information received from network interface 58 and memory 66. Processor 62 includes any hardware and/or software that operates to control and process information. For example, processor 62 executes manufacturer device management application 70 to control the operation of manufacturer device 54. Processor 62 may be a programmable logic device, a microcontroller, a microprocessor, any processing device, or any combination of the preceding.

Memory 66 stores, either permanently or temporarily, data, operational software, or other information for processor 62. Memory 66 includes any one or a combination of volatile or non-volatile local or remote devices suitable for storing information. For example, memory 66 may include RAM, ROM, magnetic storage devices, optical storage devices, or any other information storage device or a combination of these devices. While illustrated as including particular modules, memory 66 may include any information for use in the operation of manufacturer device 54.

In the illustrated embodiment, memory 66 includes manufacturer device management application 70, device information 74, patches 78, requirements 82, and confirmation reports 86. Manufacturer device management application 70 represents any suitable set of instructions, logic, or code embodied in a computer-readable storage medium and operable to facilitate the operation of manufacturer device 54.

Device information 74 represents any information regarding device 14, computing system 18, components of device 14, and/or components of computing system 18. For example, device information 74 includes information regarding the owner of device 14, information regarding any applications installed in computing system 18, address information for communicating with computing system 18, information associated with unique element 30 of computing system 18 (e.g., such as information that identifies a particular unique element 30 as being associated with a particular computing system 18 and information that identifies the unique identifier of unique element 30), any information that may be needed to communicate and/or locate device 14 and/or computing system 18, any other information required for installation of patch 78 on computing system 18, or any combination of the preceding.

Patch 78 represents a set of instructions, logic or code for installation on computing system 18. Patch 78 may be designed to fix known problems associated with computing system 78 and/or may be designed to update computing system 18, one or more applications and/or instructions associated with computing system 18, and/or any data stored or supporting computing system 18. Patch 78 may be configured to fix and/or update a portion of computing system 18 or the entire computing system 18.

Requirements 82 may represent information regarding what is required in order for patch 78 to be installed in computing system 18. For example, in an embodiment where device 14 is an automobile, requirements 86 may include the requirement that the automobile engine be turned off, that the automobile engine be at a room temperature, that the automobile has a particular status, that the automobile is currently located at an authorized service center and is being worked on by an authorized mechanic, that computing system 18 of the automobile is operating using a particular version of software, that the installation of the patch has been approved by the owner or user of the automobile, any other requirement, or any combination of the preceding. As another example, in an embodiment where a computing system is a cloud-based server, requirements 82 may include the requirement that the computing system is operating with a particular workload (such as little to no workload), that one or more virtual machines (and/or applications) running on the computing system may be transferred (or migrated) to another computing system without affecting the performance of the virtual machine (and/or application), that none of the virtual machines (and/or applications) that are implemented on the computing system are currently running, that the installation of the patch has been approved by the owner or user of the computing system and/or by the third party using each virtual machine, any other requirement, or any combination of the preceding.

In particular embodiments, requirements 82 may be provided to computing system 18 along with patch 78 so as to ensure that patch 78 is not installed on computing system 18 until requirements 82 have been satisfied.

Confirmation report 86 represents any information regarding an installation process of patch 78 on computing system 18. For example, confirmation report 86 may include any information that indicates the date and/or time patch 78 was installed on computing system 18, the context information 46 that satisfied requirements 82 (e.g., such as a list of the context information 46), the status of the installation of patch 78 (such as successful or failed), identification of patch 78, identification of device 14, identification of computing system 18, identification of unique element 30, any signature by unique element 30, any other information that may provide evidence of whether or not patch 78 was successfully installed on computing system 18, or any combination of the preceding. In particular embodiments, confirmation report 86 is stored as evidence of whether or not patch 78 was successfully installed on computing system 18. In particular embodiments, confirmation report 86 may be undeniable proof regarding whether or not patch 78 was successfully installed on computing system 18.

In an example embodiment of operations, in order for computing system 18 to install patch 78, manufacturer device 54 may transmit a message 100 that includes patch 78 and requirements 82 to computing system 18. In response to receiving message 100, computing system 18 may transmit a message 104 that indicates that computing system 18 has received message 100. In particular embodiments, message 104 may be optional. Based on requirements 82 from message 100, collector management application 44 may collect context information 46 from sensors 34 so as to determine whether requirements 82 are satisfied. In particular embodiments, context management application 44 may continue to repeatedly collect context information 46 from sensors 34 until it is determined that context information 46 satisfies each of the requirements 82 needed in order to install patch 78 on computing system 18. Once requirements 82 have been satisfied, collector management application 44 may conduct an installation process of patch 78 on computing system 18.

When the installation process of patch 78 is finished (e.g., patch 78 has been successfully installed on computing system 18, patch 78 has failed to install on computing system 18, or collector management application 44 has stopped attempting to install application 78 on computing system 18), confirmation report 86 may be generated and signed by unique element 30 of computing system 18. Computing system 18 may then transmit a message 108 that includes confirmation report 86 to manufacturer device 54 for storage as evidence of whether patch 78 was successfully installed in computing system 18.

Although system 10 illustrates the transmittal of message 100 occurring over network 50, in particular embodiments, message 100 may be included in a portable storage medium that may be coupled to network interface 22 of computing system 18. As such, when it is time for patch 78 and requirements 82 to be transmitted to computing system 18, the portable storage medium may be sent to an address associated with the owner of device 14. The portable storage medium may then be coupled to computing system 18 in order for computing system 18 to receive patch 78 and requirements 82. Furthermore, computing system 18 may further transmit confirmation report 86 to the portable storage medium. Thus, when the portable storage medium is sent back to manufacturer device 54, manufacturer device 54 may receive confirmation report 86 and store it as evidence of whether the installation of patch 78 was successful.

Modifications, additions, or omissions may be made to system 10 without departing from the scope of the disclosure. For example, manufacturer device 14 may provide any number of patches 78 to any number of computing systems 18 embedded in any number of devices 14. Additionally, system 10 may include any number of devices 14, computing systems 18, networks 50, and/or manufacturer devices 54. Any suitable logic may perform the functions of system 10 and the components within system 10.

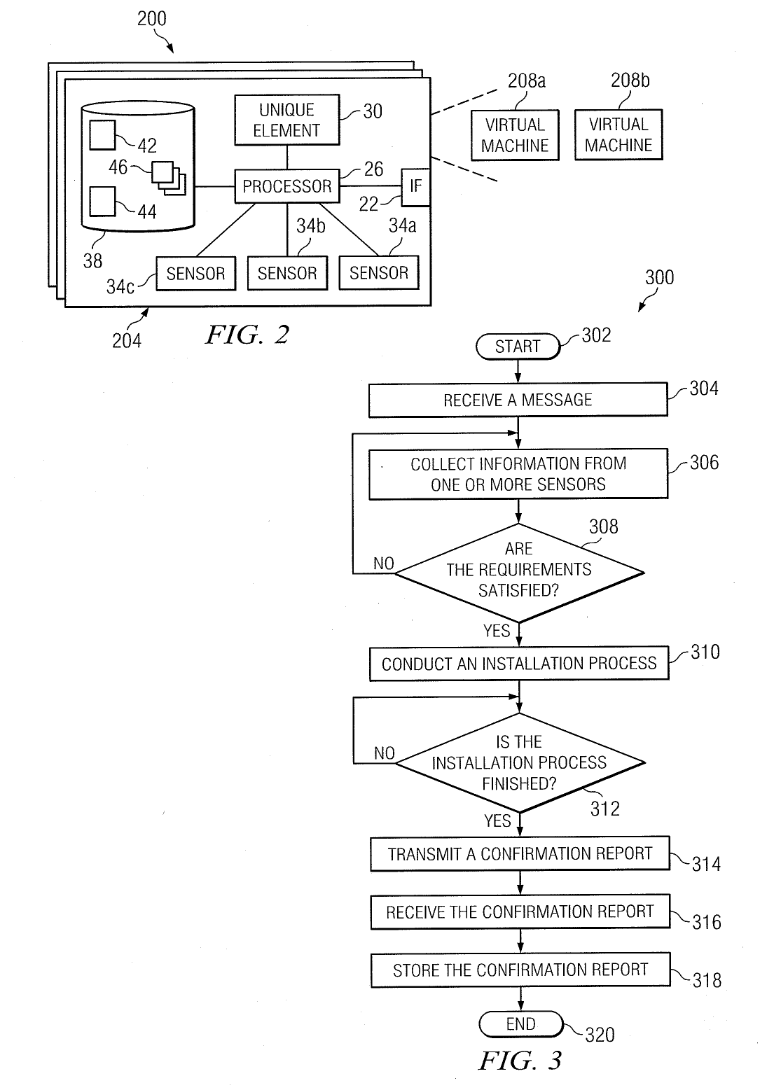

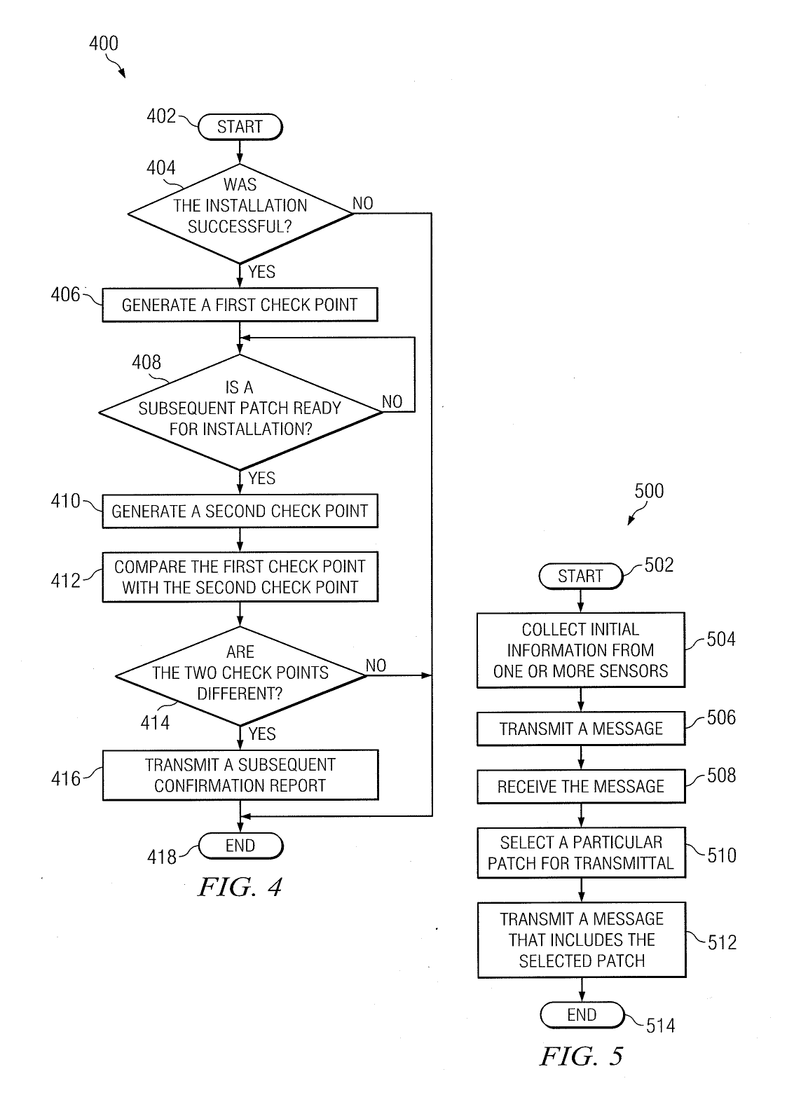

In addition to the embodiments discussed above with regard to FIG. 1, further embodiments are discussed below. In particular, FIG. 2 illustrates a system that provides for installation of a patch on a computing system that implements one of more virtual machines. Additionally, various methods that may be conducted by one or more of these embodiments are also discussed below. In particular, FIG. 3 illustrates a method for installing patches on computing systems, FIG. 4 illustrates a method for generating check points for particular embodiments of a computing system, and FIG. 5 illustrates a method for selecting a patch for a computing system.

FIG. 2 illustrates a system 200 that provides for installation of a patch on a computing system 204 that implements one or more virtual machines 208. In particular embodiments, computing system 204 may be an alternative embodiment of device 14 and computing system 18 of FIG. 1. For example, instead of computing system 18 (which is embedded in device 14) receiving message 100 from manufacturer device 54, conducting an installation process of patch 78, and transmitting message 108 to manufacturer device 54 (as is illustrated in FIG. 1), in FIG. 2, computing system 204 receives message 100 from manufacturer device 54, conducts an installation process of patch 78, and transmits message 108 to manufacturer device 54.

Typically, installing a patch on a computing system that is implementing one or more virtual machines has been problematic because such an installation may affect the performance of the virtual machines being implemented on the computing system. Since a third party may be utilizing the virtual machines implemented on the computing system at any time and for any duration, any installation process that could affect the performance of the virtual machines may be impractical. Furthermore, since the virtual machines may be utilized at any given time, it is further problematic to schedule a time when the virtual machines may be shut down so as to allow a patch to be installed using the typical processes. As such, the typical method for installing a patch on a computing system that implements virtual machines is deficient.

According to the illustrated embodiment, system 200 includes computing system 204 that implements one or more virtual machines 204. As is illustrated in FIG. 1, computing system 18 receives a patch 78 and one or more requirements 82 from a manufacturer device 54. Once computing system 18 determines that requirements 82 have been satisfied, computing system 18 may conduct an installation process for installing patch 78 on computing system 18. In particular embodiments, this may allow computing system 18 to install patch 78 even though computing system 204 implements virtual machines 208 that may be utilized by a third party at any time.

Computing system 204 represents any components that may implement virtual machines 208. Computing system 204 may include a cloud server, network server, any remote server, a mainframe, a host computer, a workstation, a web server, a personal computer, a file server, or any other device operable to implement virtual machines 208. The functions of computing system 204 may be performed by any combination of one or more servers or other components at one or more locations.

The server may include one or more servers at the same or remote locations. In the illustrated embodiment, computing device 204 includes a network interface 22, a processor 26, a unique element 30, sensors 34, a memory 38, a computing system management application 42, a collector management application 44, and context information 46, each of which is described in detail in FIG. 1.

Computing system implements virtual machines 208. Virtual machine 208 may be a running instantiation of a device, such as a computer system, that can execute or operate in a virtualized execution environment. For example, virtual machine 208 may emulate the hardware (such as the microprocessor or controller) of the device, and may further emulate an operating system that may run one or more applications installed on the virtual machine 208. In a particular implementation, virtual machine 208 fully simulates the complete hardware of the device, allowing a guest operating system to run in connection with virtual machine 208 and one or more applications to run in connection with the guest operating system.

Virtual machine 208 can be implemented using a Type 1 or Type 2 hypervisor. A Type 1 hypervisor runs directly on the hardware; a Type 2 hypervisor runs on another operating system, such as Linux. Virtual machine 208 can run any operating system supported by the virtual hardware, and can also run any application. For example, virtual machine 208 may host one “guest” operating system and one or more applications.

In an example embodiment of operations, (as is illustrated in FIG. 1) in order for computing system 18 to install patch 78, manufacturer device 54 may transmit a message 100 that includes patch 78 and requirements 82 to computing system 18. In response to receiving message 100, computing system 18 may transmit a message 104 that indicates that computing system 18 has received message 100. In particular embodiments, message 104 may be optional. Based on requirements 82 from message 100, collector management application 44 may collect context information 46 from sensors 34 so as to determine whether requirements 82 are satisfied. In particular embodiments, context management application 44 may continue to repeatedly collect context information 46 from sensors 34 until it is determined that context information 46 satisfies each of the requirements 82 needed in order to install patch 78 on computing system 18. Once requirements 82 have been satisfied, collector management application 44 may conduct an installation process of patch 78 on computing system 18.

When the installation process of patch 78 is finished (e.g., patch 78 has been successfully installed on computing system 18, patch 78 has failed to install on computing system 18, or collector management application 44 has stopped attempting to install application 78 on computing system 18), confirmation report 86 may be generated and signed by unique element 30 of computing system 18. Computing system 18 may then transmit a message 108 that includes confirmation report 86 to manufacturer device 54 for storage as evidence of whether patch 78 was successfully installed in computing system 18.

Modifications, additions, or omissions may be made to system 200 without departing from the scope of the disclosure. For example, system 200 may include any number of computing systems 204 and any number of virtual machines 208. As another example, the message that include the patch and requirements may be transmitted to the computing system from a centralized patch controller that controls each of the computing systems 204, as opposed to being transmitted from manufacturer device 54. Any suitable logic may perform the functions of system 200 and the components within system 200.

FIG. 3 illustrates a method 300 for installing patches on computing systems. In particular embodiments, one or more steps of method 300 may be performed by computing system 18 (and/or one or more components of computing system 18) of FIG. 1, computing system 204 (and/or one or more components of computing system 204) of FIG. 2, and/or manufacturer device 54 of FIG. 1.

The method begins at step 302. At step 304, a message is received. In particular embodiments, the message is received by a computing system. For example, the computing system may be a computing system that is embedded in a device (such as an automobile, a mobile phone, a DVD player, a digital camera, a printer, an electronic medical device, or any other device that includes a computing system embedded in it). As another example, the computing system may be a computing system that implements one or more virtual machines, such as a cloud server that runs the one or more virtual machines. In particular embodiments, the received message may include a patch for installation and one or more requirements to be satisfied before the patch can be installed. In particular embodiments, the patch may be configured to update the computing system.

In particular embodiments, the message may be received for any reason. For example, the message may be received because the computing system has requested a new patch, the manufacturer device has determined that the computing system requires a new patch, or any other reason. In particular embodiments, the computing system may access the manufacturer device in order to determine whether there are any new patches available. In particular embodiments, the process of checking for new patches may occur periodically and/or upon the occurrence of a pre-defined event (e.g., such as when the computing device determines that the previous patch was installed over two years ago). In particular embodiments, if the computing system determines that there are new patches available, the computing system may require that the patches be downloaded and installed.

In particular embodiments, in order to insure that the patch is being installed on the proper computing system, the message received by the computing system may be encrypted. In particular embodiments, the encrypted message may only be decrypted by a unique element associated with the computing system. For example, a message including the patch and requirements may be encrypted based on the public key in a key pair, and the unique element may include the private key of the key pair. As such, the unique element may decrypt the message so that the computing system may install the patch when the requirements are satisfied. In particular embodiments, by encrypting the message, if the message is received by the wrong computing system (e.g., such as if the message is improperly routed to the wrong computing system) the computing system will not have the proper unique element for decrypting the message. As such, in particular embodiments, the computing system may be prevented from installing an improper patch.

In particular embodiments, after the computing system receives the message at step 304, the computing system may transmit a message that indicates that the patch and requirements were received. In particular embodiments, such a message may be optional.

At step 306, information is collected from one or more sensors. In particular embodiments, the information may be collected based on the received requirements.

For example, in order to determine whether the requirements are satisfied, computing system may collect information associated with the requirements. In particular embodiments, any information may be collected. For example, the information may include information associated with the computing system (or the device that the computing system is embedded in), information regarding the environment of the device (such as temperature), the location of the computing system, information input into the computing system by a user (such as a user's approval of the patch), any other information associated with the requirements, or any combination of the preceding. In particular embodiments, the information may be collected from any type of sensor.

At step 308, it is determined whether the requirements are satisfied. In particular embodiments, the requirements are satisfied when each of the requirements have been met. For example, in particular embodiments where a requirement requires that the engine of an automobile to be turned off, the requirement may be satisfied when the engine is turned off. If the requirements are not satisfied, the method moves back to step 306 where information is collected from one or more sensors. In particular embodiments, this may allow information to be repeatedly collected from the sensors until the requirements have been satisfied.

If the requirements are satisfied, the method moves to step 310 where an installation process is conducted. In particular embodiments, conducting an installation process may refer to conducting an installation process of the patch in the computing system.

At step 312, it is determined whether the installation process is finished. In particular embodiments, the installation process may be finished for any reason. For example, the installation process may be finished because the installation was successful, the installation failed, or the computing system has stopped the installation process for any reason. If it is determined that the installation process is not finished, the method continues to check on whether the installation process is finished until the installation process is finished.

Once the installation process is finished, the method moves to step 314 where a confirmation report is transmitted. In particular embodiments, the confirmation report is transmitted by the computing system to a manufacturer device. In particular embodiments, the manufacturer device may include any device associated with any type of manufacturer, such as a manufacturer of device 14, computing system 18 (and/or one or more components of computing system 18), and/or patch 78.

In particular embodiments, the confirmation report may include any information regarding the installation process of the patch. For example, the confirmation report may include any information that indicates the date and/or time the patch was installed on the computing system, the context information that satisfied the requirements (e.g., such as a list of the context information), the status of the installation of the patch (such as successful or failed), identification of the patch, identification of the device the computing system is embedded in, identification of the computing system, identification of the unique element associated with the computing system, any signature by the unique element, any other information that may provide evidence of whether or not the patch was successfully installed on the computing system, or any combination of the preceding. In particular embodiments, the confirmation report may have been generated and signed by the unique element associated with the computing system. In particular embodiments, the unique element may sign the confirmation report in any way. For example, the unique element may insert its unique identifier (such as its unique key) in the confirmation report. In particular embodiments, by transmitting a confirmation report that has been generated and signed by the unique element, a third party (such as a manufacturer) may be able to trust that the confirmation report refers to an installation process that occurred at a particular computing system. As such, the confirmation report may be stored as evidence of the installation process.

After the confirmation report has been transmitted at step 314, the method moves to step 316 where the confirmation report is received. In particular embodiments, the confirmation report is received by the manufacturer device. At step 318, the confirmation report is stored. In particular embodiments, the confirmation report may be stored by the manufacturer device. In particular embodiments, the confirmation report may be stored as evidence of whether the patch was successfully installed. For example, the confirmation report may be stored as evidence that the patch was successfully installed, that the patch was not successfully installed, or that the installation process was stopped for any particular reason. After the confirmation report has been stored, the method moves to step 320, where the method ends.

Modifications, additions, or omissions may be made to method 300. For example, although method 300 illustrates the confirmation report being communicated to the same manufacturer device that sent the patch and requirements, in particular embodiments, the confirmation report may be sent to a different manufacturer device. Additionally, one or more steps in method 300 in FIG. 3 may be performed in parallel or in any suitable order.

FIG. 4 illustrates a method 400 for generating check points for particular embodiments of the computing system in the method of FIG. 3. In particular embodiments, one or more steps of method 400 may be performed by computing system 18 (and/or one or more components of computing system 18) of FIG. 1 and/or computing system 204 (and/or one or more components of computing system 204) of FIG. 2.

The method begins at step 402. At step 404, it is determined whether the installation of a patch was successful. If the installation of the patch was unsuccessful, the method moves to step 418, where the method ends. On the other hand, if the installation was successful, the method moves to step 406.

At step 406, a first check point is generated. A first check point may represent a check point that allows the computing system to be restored back to the time when the check point was generated. In particular embodiments, this may allow the computing system to erase one or more errors that have occurred since the check point was generated. In particular embodiments, the first check point may be generated immediately after it is determined that the installation of the patch was successful.

At step 408, it is determined whether a subsequent patch is ready for installation on the computing system. In particular embodiments, a subsequent patch may be ready for installation if the computing system has received another message from the manufacturer device, and the requirements for the subsequent patch have been satisfied. If a subsequent patch is not ready for installation, the method may continue to check for whether a subsequent patch is ready for installation. On the other hand, if a subsequent patch is ready for installation, the method moves to step 410.

At step 410, a second check point is generated. In particular embodiments, the second check point may be generated before the subsequent patch is installed. For example, the second check point may be generated immediately before the second patch is installed.

At step 412, the first check point is compared with the second check point. Based on this comparison, it is determined, at step 414, whether the two check points are different. In particular embodiments, the two check points may be different when an error has occurred in the computing system after the first check point. As another example, the check points may be different when an unknown update has occurred in the computing system (e.g., such as when an unknown patch has been installed in the computing system) and/or if malicious software has been installed on the computing system. If it is determined that the two check points are not different, the method moves to step 418, where the method ends. In particular embodiments, if it is determined that the two check points are not different, method 400 may further include installing the subsequent patch on the computing system prior to method 400 ending.

On the other hand, if it is determined that the two check points are different, the method moves to step 416. At step 416, a subsequent confirmation report is transmitted. In particular embodiments, the subsequent confirmation report may indicate that an error has occurred in the computing system since the successful installation of the first patch. In particular embodiments, the subsequent confirmation report may have been generated and signed by the unique element associated with the computing system. Once the subsequent confirmation report is transmitted, the method moves to step 418, where the method ends. In particular embodiments, after the subsequent confirmation report is transmitted, method 400 may further include restoring the computing system back to the first check point prior to method 400 ending.

Modifications, additions, or omissions may be made to method 400. For example, although method 400 describes the second check point as being used to determine whether an error has occurred since the last successful patch installation, in particular embodiments, the second check point (or any check point that is generated immediately prior to installation of a patch) may also provide a fail safe in case the installation of the subsequent patch fails. In particular, if the subsequent patch fails to install for any reason, the computing system may be restored back to that check point and the computing system may make sure that it is still in working condition. In particular embodiments, this may allow the computing system to continue operating even if an installation of a patch fails. Furthermore, in addition to restoring the computing system to the previous check point, in particular embodiments, if the installation fails for any reason, the computing system may further determine the reason for the failure and may also include that reason in a confirmation report transmitted to the manufacturer device.

Additionally, one or more steps in method 400 in FIG. 4 may be performed in parallel or in any suitable order. Furthermore, method 400 of FIG. 4 may be conducted simultaneously with method 300 of FIG. 3. For example, method 400 of FIG. 4 may begin after the installation process is determined to be finished at step 312 of FIG. 3. Accordingly, the steps of method 400 of FIG. 4 may occur simultaneously with, or after, one or more of the remaining steps of FIG. 3.

FIG. 5 illustrates a method 500 for selecting a patch for a computing system. In particular embodiments, one or more steps of method 500 may be performed by computing system 18 (and/or one or more components of computing system 18) of FIG. 1, computing system 204 (and/or one or more components of computing system 204) of FIG. 2, and/or manufacturer device 54 of FIG. 1. The method begins at step 502. At step 504, initial information is collected from one or more sensors. In particular embodiments, the initial information may include any information. For example, the information may include an indication of the computing system, the device the computing system is embedded in, one or more applications and/or virtual machines being run by the computing system, the last update and/or patch that was installed on the computing system, any other information regarding the computing system and/or the device the computing system is embedded in, or any combination of the preceding. In particular embodiments, the initial information may be collected by the computing system.

At step 506, a message is transmitted. In particular embodiments, the message may be transmitted by the computing system to a manufacturer device. In particular embodiments, the message may include the collected initial information. In particular embodiments, not only may the computing system transmit the collected initial information, but the collected initial information may also be signed by the unique element. As such, the manufacturer device may be able to determine that the collected initial information was collected from the computing system. In particular embodiments, this may prevent other devices from providing fake information on behalf of the computing system in an attempt to cause an improper patch installation.

At step 508, the message is received. In particular embodiments, the message is received by the manufacturer device. At step 510, a particular patch is selected for transmittal to the computing system. In particular embodiments, the particular patch may be selected based on the collected initial information. For example, based on the collected initial information, the manufacturer device may determine what type of computing system the computing system is, what type of applications and/or virtual machines are running on the computing system, when the last patch was installed on the computing system, any other information regarding the computing system and/or the device that the computing system is embedded in, or any combination of the preceding. In particular embodiments, selecting the particular patch based on the collected initial information may allow for selection of the best patch for each particular computing system (e.g., since different computing systems may be at different stages of the patching process and may need different patches). In particular embodiments, the manufacturer device may select any patch for installation by the computing system. For example, the manufacturer device may select a patch that is needed for the computing system, a patch that would make the computing system more efficient, and/or any other patch. In particular embodiments, the manufacturer device may further select particular requirements that need to be satisfied prior to the patch being installed on the computing system.

Once the particular patch has been selected, the method moves to step 512. At step 512, a message that includes the selected patch is transmitted. In particular embodiments, the message that includes the selected patch may be transmitted by the manufacturer device to the computing system.

After the message is transmitted, the method moves to step 514, where the method ends. Although method 500 illustrates method 500 ending after the message is transmitted to the computing system, in particular embodiments, the method may, instead, move to step 302 of method 300 of FIG. 3.

Modifications, additions, or omissions may be made to method 500. Additionally, one or more steps in method 500 in FIG. 5 may be performed in parallel or in any suitable order.

Although the present disclosure has been described with several embodiments, a myriad of changes, variations, alterations, transformations, and modifications may be suggested to one skilled in the art, and it is intended that the present disclosure encompass such changes, variations, alterations, transformations, and modifications as fall within the scope of the appended claims.

What is claimed is:

1. A system comprising:
an automobile; and
a computing system embedded in the automobile, the computing system comprising:
a unique element operable to generate and sign one or more reports so as to identify the reports as being associated with the computing system;
a memory operable to store one or more instructions; and
a processor operable, upon execution of the one or more instructions, to:
receive a message comprising a patch for installation and one or more requirements to be satisfied before the patch can be installed, the patch configured to update the computing system;
repeatedly collect information from one or more sensors until it is determined, based on the collected information, that the one or more requirements have been satisfied;
upon determining that the one or more requirements have been satisfied, conduct an installation process of the patch on the computing system; and
upon determining that the installation process of the patch is finished, transmit a confirmation report indicating whether the patch was successfully installed, the confirmation report having been generated and signed by the unique element.

2. A system comprising:
a computing system comprising:
a unique element operable to generate and sign one or more reports so as to identify the reports as being associated with the computing system;
a memory operable to store one or more instructions; and
a processor operable, upon execution of the one or more instructions, to:
receive a message comprising a patch for installation and one or more requirements to be satisfied before the patch can be installed, the patch configured to update the computing system;
repeatedly collect information from one or more sensors until it is determined, based on the collected information, that the one or more requirements have been satisfied;
upon determining that the one or more requirements have been satisfied, conduct an installation process of the patch on the computing system; and
upon determining that the installation process of the patch is finished, transmit a confirmation report indicating whether the patch was successfully installed, the confirmation report having been generated and signed by the unique element.

3. The system of claim 2, further comprising a device, wherein the computing system is embedded in the device.

4. The method of claim 3, wherein the device is selected from a group consisting of:
an automobile;
a mobile phone;
a digital versatile disk (DVD) player;
a digital camera;
a printer; and
an electronic medical device.

5. The system of claim 2, wherein the computing system comprises a cloud server that runs one or more virtual machines.

6. The system of claim 2, further comprising:
a device associated with a manufacturer, the device associated with the manufacturer comprising:
a second memory operable to store one or more second instructions; and
a second processor operable, upon execution of the one or more second instructions, to:
receive the confirmation report; and
store the confirmation report as evidence of whether the patch was successfully installed.

7. The system of claim 2, wherein the processor is further operable, upon execution of the one or more instructions, to:
upon determining that the installation process of the patch was successful, generate a first check point for the computing system;
prior to conducting an installation process of a subsequent patch on the computing system, generate a second check point for the computing system;
compare the first check point to the second check point; and
upon determining that the first check point is different from the second check point, transmit a subsequent confirmation report indicating that an error has occurred in the computing system since the successful installation of the patch, the subsequent confirmation report having been generated and signed by the unique element.

8. The system of claim 2, wherein the processor is further operable, upon execution of the one or more instructions, to:
prior to receiving the message:
collect initial information from the one or more sensors; and
transmit an initial message to a device associated with a manufacturer, the initial message comprising the collected initial information; and
wherein the device associated with the manufacturer comprises:
a second memory operable to store one or more second instructions; and
a second processor operable, upon execution of the one or more second instructions, to:
based on the collected initial information, select a particular patch to transmit to the computing system as the patch; and
transmit the message to the computing system.

9. A method comprising:
receiving, at a computing system, a message comprising a patch for installation and one or more requirements to be satisfied before the patch can be installed, the patch configured to update the computing system;
repeatedly collecting information from one or more sensors until it is determined, based on the collected information, that the one or more requirements have been satisfied;
upon determining that the one or more requirements have been satisfied, conducting an installation process of the patch on the computing system; and
upon determining that the installation process of the patch is finished, transmitting a confirmation report indicating whether the patch was successfully installed, the confirmation report having been generated and signed by a unique element associated with the computing system.

10. The method of claim 9, wherein the computing system is embedded in a device.

11. The method of claim 10, wherein the device is selected from a group consisting of:
an automobile;
a mobile phone;
a digital versatile disk (DVD) player;
a digital camera;
a printer; and
an electronic medical device.

12. The method of claim 9, wherein the computing system comprises a cloud server that runs one or more virtual machines.

13. The method of claim 9, further comprising:
receiving, at a device associated with a manufacturer, the confirmation report; and
storing the confirmation report as evidence of whether the patch was successfully installed.

14. The method of claim 9, further comprising:
upon determining that the installation process of the patch was successful, generating a first check point for the computing system;
prior to conducting an installation process of a subsequent patch on the computing system, generating a second check point for the computing system;
comparing the first check point to the second check point; and
upon determining that the first check point is different from the second check point, transmitting a subsequent confirmation report indicating that an error has occurred in the computing system since the successful installation of the patch, the subsequent confirmation report having been generated and signed by the unique element associated with the computing system.

15. The method of claim 9, further comprising:
prior to receiving the message:
collecting initial information from the one or more sensors;
transmitting an initial message to a device associated with a manufacturer, the initial message comprising the collected initial information;
based on the collected initial information, selecting, by the device associated with the manufacturer, a particular patch to transmit to the computing system as the patch; and
transmitting the message to the computing system.

16. A non-transitory computer readable medium having logic stored therein, the logic operable, when executed by a processor, to:
receive, at a computing system, a message comprising a patch for installation and one or more requirements to be satisfied before the patch can be installed, the patch configured to update the computing system;
repeatedly collect information from one or more sensors until it is determined, based on the collected information, that the one or more requirements have been satisfied;
upon determining that the one or more requirements have been satisfied, conduct an installation process of the patch on the computing system; and
upon determining that the installation process of the patch is finished, transmit a confirmation report indicating whether the patch was successfully installed, the confirmation report having been generated and signed by a unique element associated with the computing system.

17. The non-transitory computer readable medium of claim 16, wherein the computing system is embedded in a device.

18. The non-transitory computer readable medium of claim 17, wherein the device is selected from a group consisting of:
an automobile;
a mobile phone;
a digital versatile disk (DVD) player;
a digital camera;
a printer; and
an electronic medical device.

19. The non-transitory computer readable medium of claim 16, wherein the computing system comprises a cloud server that runs one or more virtual machines.

20. The non-transitory computer readable medium of claim 16, wherein the confirmation report is transmitted to a device associated with a manufacturer for storage as evidence of whether the patch was successfully installed.

21. The non-transitory computer readable medium of claim 16, wherein the logic is further operable, when executed by the processor, to:
upon determining that the installation process of the patch was successful, generate a first check point for the computing system;
prior to conducting an installation process of a subsequent patch on the computing system, generate a second check point for the computing system;
compare the first check point to the second check point; and
upon determining that the first check point is different from the second check point, transmit a subsequent confirmation report indicating that an error has occurred in the computing system since the successful installation of the patch, the subsequent confirmation report having been generated and signed by the unique element associated with the computing system.
